(19) United States
(12) Patent Application Publication
(10) Pub. No.: US 2009/0254802 A1
(43) Pub. Date: Oct. 8, 2009

(54) Publishing system and method that enables users to collaboratively create, professional appearing digital publications for "On-Demand" distribution in a variety of media that includes digital printing

(75) Inventors: Frank Campagna, Red Hook, NY (US); William Adams Hicks, Lake Katrine, NY (US)

Correspondence Address: Billy J. Knowles;BK Patents, Inc., 72 Hurley Ave., Kingston, NY, 12401, US

(73) Assignee: Print Asset Management, Inc.

(21) Appl. No.: 12/384,531

(22) Filed: Apr. 6, 2009

Related U.S. Application Data
(60) Provisional application No. 61/072,979, filed on Apr. 4, 2008.
(60) Provisional application No. 61/133,457, filed on Jun. 30, 2008.

(51) Int. Cl. G06F 17/00; G06F 15/16

(52) U.S. Cl. 715/209; 709/204; 709/206; 715/243

(57) ABSTRACT

Apparatus and methods are provided for providing publishers and authors with the organizational and creative tools to professionally create books inclusive of writing, graphics and multi-media. The apparatus and methods further enable users to design and format their publication with minimal effort. A text editor is used to manipulate the input in a “What-You-See-Is-What-You-Get” (W.Y.S.I.W.Y.G.) environment. The user is able to professionally design a publication. The publication is previewed with images of the “print-ready” publication. Publishing resource tools are provided that allow the publisher, author and other collaborators to create and edit content. The publisher and authors can select from provided design styles and images or upload their own images to create professional looking publications. The publication is converted to a “print-ready file” and or an e-book and stored in a database. A bookstore associated with the apparatus and methods allow books to be viewed and purchased.

This application claims priority under 35 U.S.C. §119 to U.S. Provisional Patent Application Ser. No. 61/072,979, filed on Apr. 4, 2008, which is herein incorporated by reference in its entirety.

This application claims priority under 35 U.S.C. §119 to U.S. Provisional Patent Application Ser. No. 61/133,457, filed on Jun. 30, 2008, which is herein incorporated by reference in its entirety.

### BACKGROUND OF THE INVENTION

1. Field of the Invention

This invention relates generally to document publication systems. More particularly, this invention relates to electronic publication systems that enable users to collaboratively create professional appearing digital publications for distribution.

2. Description of Related Art

Advancements in Internet performance, web development tools, personal digital assistants (PDA's), and general computing and computer support devices have nurtured the world's demand for immediate and new information (content). In addition these same advancements have created opportunities within the increasing DIY (do-it-yourself) market, specifically with regard to Self-Publishing.

Self-Publishing is the most rapidly expanding segment of the publishing industry. According to the (PMA) Publishers Marketing Association statistics, there are currently more than 86,000 smaller publishers in the United States that generated over 27 billion dollars in sales. In 1981 there were only 12,000 publishers. This growing market segment has been advanced by Internet and print technologies that have reduced cost, improved quality and made consumer access possible.

Print-on-demand (POD) is a revolutionary technology that enables publishers to print books as they are ordered in quantities as few as one book. Print-on-demand eliminates three of the biggest problems in the book industry: Books going out of print, unsold inventories, and the need to warehouse inventories. Under the “POD Publishing” model, book publishers can publish more titles from more authors with minimal financial exposure. The POD process requires that manuscripts are formatted or designed in digital form. This digital book is stored on a server and made available through an online bookstore. As single or bulk orders are received the digital book file can be sent to a digital printer, where the single book or books are printed, bound and shipped. Books can also be made available “on-demand” as a downloadable audio and electronic books or e-books.

It is predicted that online book sales will double between 2003 and 2008, going from $2.8 billion in late 2003 to $5.5 billion in 2008. Roughly five million new U.S. households will shop online each of the next five years, growing the e-commerce market to 63 million households by '08.

Currently there are from 8,000 to 11,000 new publishers entering the publishing field every year. Most new publishers are self-publishing authors that are authoring their own content and then arranging for the design of book from page layout to cover design.

In 2007 there were 138,000 new titles were issued International Standard Book Numbers (ISBN). The average number of copies sold per title of a POD company that printed 10,000 different titles is 75 books. Coupled with this, the largest growth area in publishing is currently e-books. In January 2006, e-book sales jumped by over 50%.

Seventy-five percent of 300 booksellers surveyed (half from independent bookstores and half from chains) identified the look and design of the book cover as the most important component. They agreed that the jacket is prime real estate for promoting a book.

Self-publishers, on average, pay from $465.17 for a simple cover design to as much as $3,533.26 for a complex cover design. A book design can cost as much as $150 per hour that breaks down to between $5 and $18 per page for interior page layout.

Citation: Para Publishing—Welcome to Para Publishing. Ed. Dan Poynter. 8 Mar. 2008. Para Publishing. 5 Apr. 2009, http://www.parapublishing.com/sites/para/resources/statistics.cfm>.

Although technology has advanced the digital book printing process to a quality level that in many cases exceeds traditional processes, the fact remains that a quality print job cannot improve a poorly designed book. Services offered by the top POD Publishing companies require that the authors either design and format their books on their own or pay high upfront fees to have this done. In a few cases the author can access a very limited do-it-yourself cover designer. The majority of Authors that opt to design their own books use word processing programs such as Microsoft Word, from Microsoft Corporation Redmond Oreg. 98052, a popular application that is easy to use but is limited in how professional a book can appear. An amateur looking design devalues the value of the author's content and book. As an option authors may chose to purchase professional design software like Adobe InDesign, from Adobe Corporation, San Jose, Calif. 95110, at a cost that exceeds $500. Programs like this allow users endless possibilities in design, the problem is they are difficult and time consuming to learn. These programs do not provide solutions for co-authoring or collaborative publishing through a central program that communicates easily through a network such as Internet using computer programs that are commonly referred to as Web 2.0 tools. The Authors roles and relationship to the sites are limited to publishing and buying. Authors do not use these competitor websites to seek collaboration with other authors' or service providers when publishing a book.

It is known that, in academia, American students need to improve writing skills to meet the requirements of higher education and business. Writing is a skill that is essential to succeed in school, college, and in life in general. To illustrate the current state of the art of the writing skills of students, it can be shown that as of 2002 that 69% of eighth grade students and 77% of twelfth grade students scored below proficient levels in writing. It is further known that approximately 50% of first year college students are unable to produce papers that are relatively free of language errors. It can be shown that, when students write with a purpose and for an audience, they take ownership and are motivated to write their best.

### SUMMARY OF THE INVENTION

What is needed are systems or methods that provide a self-published author and the associated collaborators an environment where they can easily assume one or more roles required in the publishing process and create a publication—book, e-book, etc. easily and at relatively low cost. Once the publication is complete, the author must be able to have access to a distribution and marketing process that allows for sales and sharing of the content created.

Further, what is needed in an academic environment are publication systems and methods for stimulating students to embrace the process for learning the critical thinking skills for creating intellectual content for independent publication.

The problem of self-publishers or independent publishers having too many barriers prevent them from efficiently disseminating their intellectual content as professionally appearing books, deliverable in both electronic and printed formats is solved by a book creation and publishing system. The book creation and publishing system allows its users that are the independent publishers and optional collaborators lacking knowledge, skills, and publishing equipment to create and publish a book. The book design and creation system includes a genre selector, a book section/sub-section partitioner, an editing apparatus, and a cover designer. The genre selector assists the user in selecting one of a plurality of genre to which the book will be assigned. Each genre includes at least one template providing structure for the book to be designed.

The section partitioner in communication with the template allows the user to select at least one section to be incorporated into the book. Within the section partitioner is a subsection partitioner in communication with the template to allow the user to organize and edit specific sub-sections (i.e. chapters, sub-chapters, paragraphs, illustrations, etc.) within each book section. The editing apparatus is in communication with at least one of the sections of the book to allow the user to generate and edit content of inserted into the section. The cover designer calculates the book size and allows the user to generate and edit the content to be displayed on the cover.

The book creation and publishing system includes a user permission apparatus to allow permission to be granted to the users that are authors, collaborators, editors and publishers of the book. The book creation and publishing system further includes a plurality of collaboration tools that allow multiple users with permissions to access the book contents to communicate in the generation and editing of the content. The collaboration tools include a commenting device and a messaging device. The commenting device provides a notational device that is anchored to selected portions of the content for communication of recommendations and comments regarding the selected portions of content. The messaging device allows the users with permissions to access the book to communicate with regards to a selected portion of the content by sending short text messages within a network environment to one another.

The book creation and publishing system also includes a distribution system for preparation of the book for printing or disseminating as a physical book or as an e-book. A bookstore is within the book creation and publishing system to allow for promotion and sales of the physical book or e-book. The physical book or the e-book may include audio and visual media to augment the text and illustrations of the physical book or the e-book.

In other embodiments, the problem of self-publishers or independent publishers disseminating their content as professionally appearing books, deliverable in both electronic and printed formats is solved by a book creation and publishing method. The book creation and publishing method includes the steps of selecting a genre from a database of a plurality of genres, partitioning the book into sections and sub-sections, editing the content of the book, and designing a cover for the book. In selecting the genre, a user determines the genre to which the book will be assigned and a template of a plurality of templates describing a format for the genre.

In partitioning the book into sections, the partitioning allows the user to organize and edit specific sub-sections (i.e. chapters, sub-chapters, paragraphs, illustrations, etc.) within each book section. In editing, at least one of the sections of the book the user generates and edits the content inserted into the section. In designing cover, the book size is calculated and content (text and illustrations) to be displayed on the cover is generated and edited.

The book creation and publishing method further includes granting by a user permission to allow other users that are writers, collaborators, editors, designers, and publishers of the book. The book creation and publishing method additionally includes collaborating of multiple users with permissions to access the book contents to communicate in the generation and editing of the content. In collaborating, the user collaboration tools include a commenting device and a messaging device. The commenting device provides a notational device that is anchored to selected portions of the content for communication of recommendations and comments regarding the selected portions of content. The messaging device allows the users with permissions to access the book to communicate with regards to a selected portion of the content by sending short text messages within a network environment to one another.

The book creation and publishing method further includes formatting the book for printing and disseminating as a physical book or as an e-book. The book creation and publishing method also includes receiving the book or e-book and selling the book or e-book to a customer.

In still other embodiments, a computer-accessible data storage medium having instruction data code, which, when executed on a computer, perform a book creation and publishing method that performs the functions of a as described above.

In still other embodiments, a business method for creating and preparing a book for sale includes the steps of selecting a genre from a database of a plurality of genres, a partitioning the book into sections and sub-sections, editing the content of the book, and designing a cover for the book. In selecting the genre, a user determines the genre to which the book will be assigned and a template from a plurality of templates describing a format for the genre.

In partitioning the book into sections, the partitioning allows the user to organize and edit specific sub-sections (i.e. chapters, sub-chapters, paragraphs, illustrations, etc.) within each book section. In editing at least one of the sections of the book, the user generates and edits the content inserted into the section. In designing cover, the book size is calculated and content to be displayed on the cover is generated and edited.

The business method for creating and preparing a book for sale further includes granting by a user permission to allow other users that are writers, collaborators, editors, designers, and publishers of the book. The business method for creating and preparing a book for sale additionally includes collaborating of multiple users with permissions to access the book contents to communicate in the generation and editing of the content. In collaborating, the uses collaboration tools include a commenting device and a messaging device. The commenting device provides a notational device that is anchored to selected portions of the content for communication of recommendations and comments regarding the selected portions of content. The messaging device allows the users with permissions to access the book to communicate with regards to a selected portion of the content by sending short text messages within a network environment to one another.

The business method for creating and preparing a book for sale further includes formatting the book for printing and disseminating as a physical book or as an e-book. The business method for creating and preparing a book for sale also includes is receiving the book or e-book and selling the book or e-book to a customer.

### BRIEF DESCRIPTION OF THE DRAWINGS

FIG. 1 is a diagram of the functions performed by a book creation and publishing system embodying the principles of this invention.

FIG. 2 is a functional block diagram illustrating a book creation and publishing system embodying the principles of this invention.

FIG. 3 is a functional block diagram of a networked computer system that executes a book creation and publishing method embodying the principles of this invention.

FIGS. 4a, 4b, 4c and 4d are flow diagrams illustrating a book creation and publishing method embodying the principles of this invention.

FIG. 5 is an exemplary screen display of a web page of an START UP page for a user to employ a book creation and publishing system and method embodying the principles of this invention.

FIG. 6 is an exemplary screen display of a web page of an initial creation of a book in a book creation and publishing system and method embodying the principles of this invention.

FIG. 7 is an exemplary screen display of a web page for entering text and images to a section of a book in a book creation and publishing system and method embodying the principles of this invention.

FIG. 8 is an exemplary screen display of a web page of a set-up page describing a book in a book creation and publishing system and method embodying the principles of this invention.

FIG. 9 is an exemplary screen display of a web page for partitioning a book in a book creation and publishing system and method embodying the principles of this invention.

FIG. 10 is an exemplary screen display of a web page for editing text in a section of a book in a book creation and publishing system and method embodying the principles of this invention.

FIG. 11 is an exemplary screen display of a web page illustrating the optional templates for adding illustration content to a book in a book creation and publishing system and method embodying the principles of this invention.

FIG. 12 is an exemplary screen display of a web page illustrating the placement of images in a book in a book creation and publishing system and method embodying the principles of this invention.

FIG. 13 is an exemplary screen display of a web page illustrating the management of projects within a book creation and publishing system and method embodying the principles of this invention.

FIG. 14 is an exemplary screen display of a web page illustrating a chat or instant messaging function for collaborators on a book to communicate in a book creation and publishing system and method embodying the principles of this invention.

FIG. 15 is an exemplary screen display of a web page illustrating “sticky note” for collaborators on a book to communicate in a book creation and publishing system and method embodying the principles of this invention.

FIG. 16 is an exemplary screen display of a web page illustrating a shared clipboard for collaborators on a book in a book creation and publishing system and method embodying the principles of this invention.

FIG. 17 is an exemplary screen display of a web page illustrating a structural framework for a cover design for a book in a book creation and publishing system and method embodying the principles of this invention.

FIG. 18 is an exemplary screen display of a web page illustrating a bookstore for distribution and selling a book in a book creation and publishing system and method embodying the principles of this invention.

FIG. 19 is an exemplary screen display of a web page for managing membership of a group of collaborators for a book in a book creation and publishing system and method embodying the principles of this invention.

### DETAILED DESCRIPTION OF THE INVENTION

In the context of the embodiments of the present invention, the following are definitions of terms as used in this specification:
content is an entire book manuscript, a grouping of single chapters or text of a manuscript, poems, essays (etc), photographs, video segments, audio clips, illustrations, book cover designs, book templates, or other textual or image matter. The matter may be for public or private usage; offered for free or for sale; may be restricted to a single usage or multiple usage; or may be restricted or locked for editing or may be unlocked or editable. Published content embodying the principles of this invention may be books, magazines, or other printed publication. The published content may also include video media, audio media such as digital video disks or compact audio disks.
Writers are persons who create textual content for a publication.
Authors are persons who create content (written or image) for usage in a publication.
Publishers are persons who create projects for promotion, distribution and sale employing the content created by authors for publication.
Editors are persons that review publications for appropriateness of content, correctness of the content, and completeness of the content for a publication.
Self-Publishers are authors or other persons that assume the roles of a publisher as well as the role of author and/or editor.

As described above, it is necessary that a self-published author and the associated collaborators have an environment where they can easily assume one or more roles required in the publishing process and create a publication—book, e-book, etc. easily and at relatively low cost. Once the publication is complete, the author must be able to have access to a distribution and marketing process that allows for sales and sharing of the content created.

This is particularly true in an academic environment where a need is felt for a book creation publication system and method to stimulate students to embrace the process for learning the critical thinking skills for creating intellectual content. It has been shown that students become more engaged in the writing process and therefore develop the critical thinking skills in an environment of collaborative writing and creation of a book. A book creation and publishing system and method embodying the principles of this invention facilitates the engagement of a group of students under the guidance and supervision of a teacher in the creation of a book.

The problem of self-publishers or independent publishers having too many barriers prevent them from efficiently disseminating their content as professionally appearing books, deliverable in both electronic and printed formats is solved by a book creation and publishing system and method embodying the principles of this invention. The book creation and publishing system allows its users that are the independent publishers and optional collaborators lacking knowledge, skills, and publishing equipment to create and publish a book.

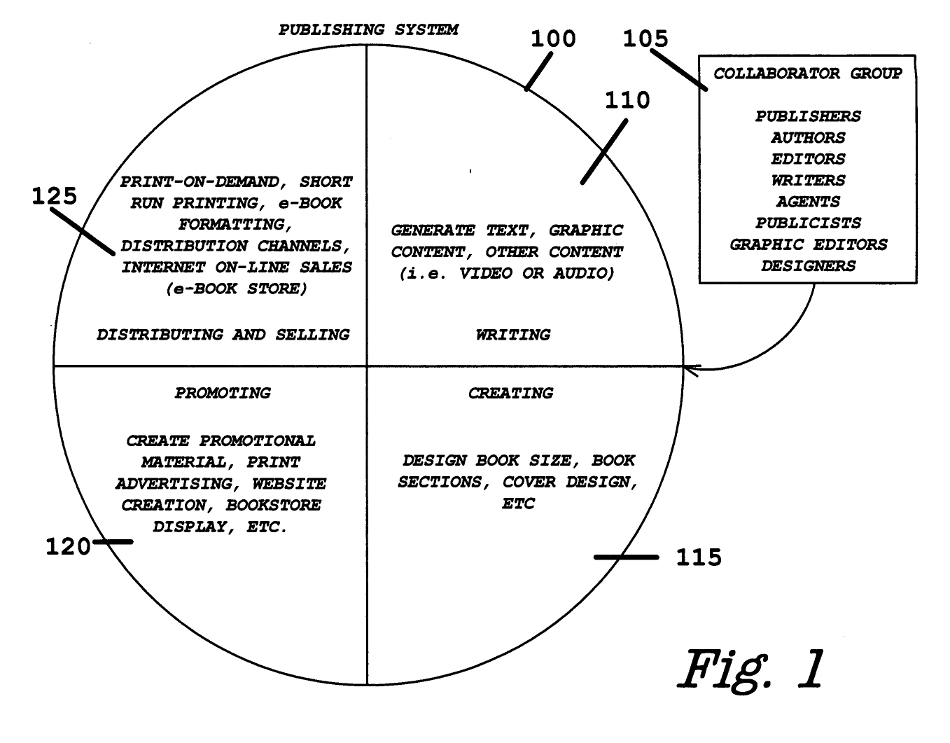

Refer now to FIG. 1 for a discussion of the functions performed by a book creation and publishing system embodying the principles of this invention. A book creation and publishing system 100 must facilitate the operations of a group of collaborators 105 in the writing 110, creating 115, promoting 120, and distributing and selling 125 of a book.

The collaborator group 105 includes publishers, authors, editors, writers, agents, publicists, graphic editors, and designers (i.e. a cover designer). This listing of the collaborator group is only exemplary and other participants may be added to the collaborator group 105 to perform necessary functions. The publisher providing the coordination of the activities of each of the participants of the collaborator group 105. The publisher in addition to the coordination function may perform other functions such as being an author of the book, as in an instance of a self-published author. The author is generally a person with an original inspiration for a book and creates much of the manuscript. An editor reviews a publication for appropriateness, correctness, and completeness of the content of a book. A writer creates additional content for a book, but is generally not the original inspiration of the book to be published. Agents are persons that collect repositories of content and represent the creators in the sale and distribution of the content. As content that is not created by an author or within the collaborator group 105 is needed to be included within the book, the agent is consulted through a library of content to acquire the content. Publicists are persons that create and distribute promotional material for sale of a book. Graphic editors provide graphic or photographic illustrations for inclusion in the book and its cover. The designers are persons that create the template for the layout of the structure of the book and assist in the creation of the cover for the book. Any or all of the skills may be performed singly or jointly by the collaborator group 105.

Within the book creation and publishing system 100, a writer and author have tools that allow writing and creating 110 of the content of the book. The content will include the text, graphic content to illustrate the book, and even other content such as audio and video content can be included with the book. In the case of physical book, a compact disc, digital video disc, or other audio or video recording media may be included with the book to act as the repository of the audio and video content.

In creating the design of the book, the publisher and the author will choose the genre of the book and select a template for the layout of the book from a database of templates. Once the layout of the book created, the content of the book is inserted into the template. The publisher, author, and editor are then editing the content of the book for appropriateness, correctness, and completeness of the content of the book. Upon completion of the content and the layout of the book within the template, a cover is designed to complete the creation of the book. The book is then forwarded to a printer for printing of the book. In the case of a self-published author or a relatively small group of collaborators 105 such as a class of students with a teacher acting as publisher, the printing of the book maybe by a print-on-demand facility. In the case of an author with a limited audience, the printing of the book is through a short-run print facility. As an alternative, the book is formatted as an e-book.

Upon completion of the creation of the book, the material for promoting 120 the book is created for advertising the sale of the book. This includes any print, radio, or television advertising. A website describing the book may be created for display on the internet. Also, any display advertising is created for a bookstore. This display advertising is as simplistic as posters and advertising sheets for sale by students in a classroom to family and friends.

During the writing 110, creating 115, and development of the material for promoting 120, the book creation and publishing system 100 provides the necessary means for distributing and selling 125 the book. The necessary arrangements with print-on-demand companies or short-run print companies are made for the printing of the book. The Is formatting and the location of the data files of the e-book are arranged and completed. The distribution channels for the sale of the book are chosen. The book can be sold through an associated on-line bookstore associated with the book creation and publishing system or may be sold through other enterprises coupled to the book creation and publishing system.

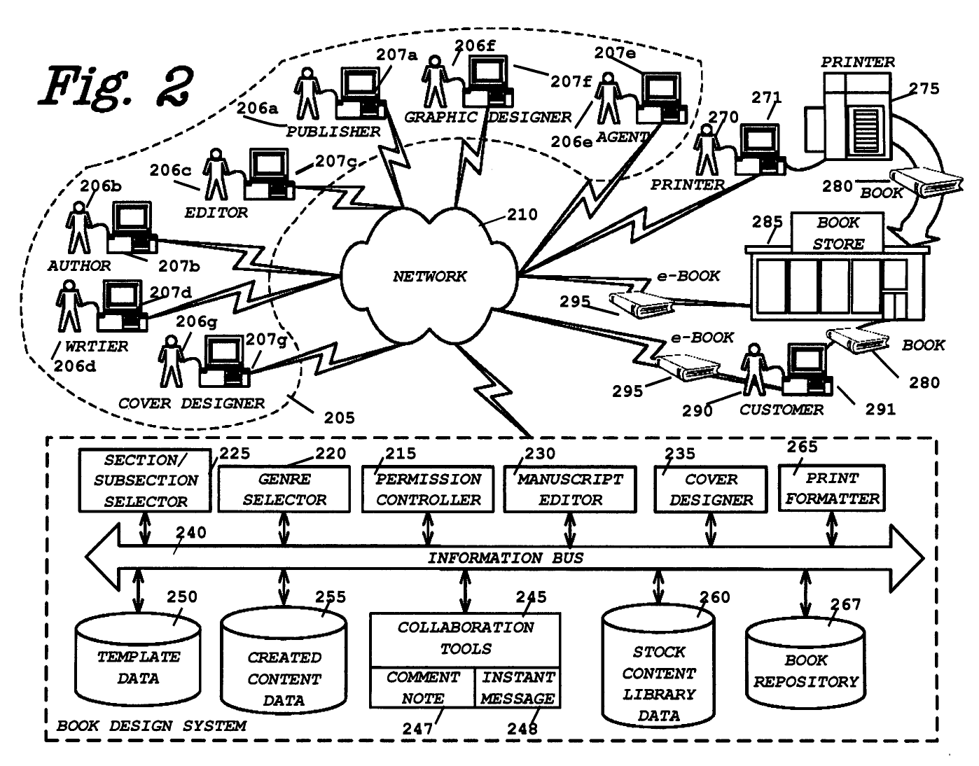

A book creation and publishing system embodying the principles of this invention is shown in the functional block diagram of FIG. 2. Referring now to FIG. 2, the book creation and publishing system 200 is in communication with a digital communications network 210 such as the internet. A collaborator group 205 includes publishers 206a, authors 206b, editors 206c, writers 206d, agents 206e, publicists, graphic designers 206f, and cover designers 206g. The collaborator group 205 as shown is exemplary and may include other persons (not shown) such as illustrators. Each collaborator 206a, 206b, . . . , 206g has access to a personal computer system 207a, 207b, . . . , 207g or any other similar computational device. Each of the personal computer systems 207a, 207b, . . . , 207g is in communication with the network 210.

The book creation and publishing system 200 includes a permission controller 215 for controlling access of the members 206a, 206b, . . . , 206g of the collaborator group 205 to book projects. The person that is designated as a publisher 206a is the person that invites other people to participate in the creation of the book. The invitee fulfils one of the rolls as a member 206a, 206b, . . . , 206g of the collaborator group 205. The publisher 206a provides an invitation password to an invitee and the invitee accesses the book creation and publishing system 200 by way of the associated personal computer system 207a, 207b, . . . , 207g through the network 210.

When a publisher 206a or author 206b begins the process of creating a book, the publisher 206a or author 206b activates the genre selector 220. The genre selector 220 provides a means for displaying the types of genres that are available for creation of the book. The genres, for example, may be fiction, non-fiction, poetry, self-help, or text book. Within the overall genres, there maybe other classifications such as fiction may include mysteries, adventure, spy thriller, romance, and any number of other classifications. Each of the genres includes at least one template defining the basic structure. The template structures for the genres are stored in the template data base 250. The genre selector 220 presents a screen display showing input areas for designating the genre and the template style within the genre. The genre selector further provides an input area for providing a title and physical dimensions of the book. It is obvious to one skilled in the art that other attributes may be described in the process of creating the structure of the book within the genre selector 220. The genre selector 220 further provides an area within the screen display illustrating a sample of the selected genre. Upon approval, the genre selector then creates the structural framework for the book.

Upon completion creation of the structural framework for the book, a section/subsection selector 225 is activated. The section/subsection selector 225 generates a display screen that illustrates the types of sections and subsections that can be chosen for use within the structural framework for the book. The types of sections and subsections that may be selections that include, for example, a title page, copyright page, a page illustrating a chapter format, a dedication page, table of contents page, and many other section and subsection page types. The section and subsection formats are then included within the book's structural framework and then the section/subsection selector 225 stores the books structural framework with the sections and the subsection to the manuscript database 255.

Once the book's structural framework with the sections and subsections are defined and stored into the manuscript database 255, the manuscript editor 230 is activated. The manuscript editor 230 retrieves the book's structural framework with the section and subsection formats and provides a screen display of the structural framework that is now enabled to accept the text and any illustrations that are to be included in the book. The author 206b and/or any writer 206d create the text either directly to a graphical user interface (GUI) of the associated personal computer 207b and 207d or by importing the text from a word processor program product such as Microsoft Word. Once the author 206b and/or any writer 206d have entered the text, an editor 206c enters the appropriate access codes into the GUI of the personal computer 207c to gain access through the permission controller 215 and activate the manuscript editor 230 to review the content of the book for appropriateness, correctness, and completeness of the content of the book. In addition to the author 206b and/or any writer 206d, the publisher 205a also may enter the appropriate access codes into the GUI of the personal computer 207a to gain access through the permission controller 215 and activate the manuscript editor 230 for entering and editing of the contents of the book.

Other collaborators 206a, 206b, . . . , 206g of the group of collaborators 205 additionally enter the appropriate access codes into the GUI of the personal computer 207a, 207b, . . . , 207g to gain access through the permission controller 215 and activate the manuscript editor 230. For instance, the graphic designer 206f may insert or edit inserted illustrations within the manuscript. Any of the illustrations for the book may be photographs or drawings that are stored in the content library database 260. The manuscript editor allows any of the collaborator group to gain access to the content library database 260 by presenting a screen display at the GUI of any of the personal computers 207a, 207b, . . . , 207g. The illustrations may be copyright free illustrations or copyrighted illustrations that the publisher must purchase before using them in the manuscript. Further, any of the collaborator group 205 may import their own illustrations to the content library data base from their personal computer system 207a, 207b, . . . , 207g. As an example, the graphic designer 206f, in addition to entering an illustration to the book, may store the illustration for future use in the content library database 260.

Upon completion of the manuscript by the collaborator group 205 by using the manuscript editor, the cover designer 235 is activated. At this point, the physical structure of the front cover, the back cover, and spine are calculated. The physical structure becomes a cover template for the book that is included with the manuscript and stored in the manuscript database 255. A cover designer 206g, or the author 206b, or the publisher 206a then enter the appropriate access codes into the GUI of the personal computer 207a, or 207b, or 207g to gain access through the permission controller 215 and again activate the cover designer 235 to enter and edit text and illustrations into the cover template.

In the process of entering and editing the book, the collaborator group 205 is able to communicate through the collaboration tools 245. The collaboration tools 245 include a commenting device 247 (sticky-note) and an instant messaging device 248. The commenting device 247 is anchored to selected portions of the content of the book for communication of recommendations and comments regarding the selected portions of content of the book. The messaging device 248 allows the collaborator group 205 to communicate by way of instant messages with regards to a selected portion of the content.

Upon completion of the manuscript and the cover of the book, the publisher 206a enters the appropriate access codes into the GUI of the personal computer 207a to gain access through the permission controller 215 and activate the print formatter 265 to generate the appropriate file formats necessary such that a printer 270 can manufacture a physical book 280. Alternately, the print formatter 265 generates the file format suitable for an e-book 295. The print files and the e-book files are then stored in the book repository 267 pending the printing and distribution.

The agent 206e collects repositories of content (books, illustrations, etc.) and represents the creators in the sale and distribution of the content. The agent 206e enters the appropriate access codes into the GUI of the personal computer 207e to gain access through the permission controller 215 and activate the deposit illustrations and other content to the content library database 260 or to extract the book print files or e-book files for transfer and sale.

The printer 270 receives the print files from the book repository 267 through his computer workstation 271 in communication with the network 210. A printing device 275 that is capable of manufacturing the book is connected to the computer workstation 271 for 1o producing the book 280. The printer may be an enterprise coupled to the book creation and publishing system 200 or in fact may be an element of the book creation and publishing system 200. The output of the printing device may be transferred directly as shown to a bookstore 285. Alternately, if the bookstore is an online entity not having a physical distribution facility, the book may be delivered directly (not shown) to the customer 290.

The bookstore 285 provides a facility for the display and promotion of the book. The customer may purchase either a physical book 280 or an electronic book 295. The bookstore 285 may store the e-book files and transfer the e-book 295 through the network 210 to the customer 290 through the customer's personal computer system 291. If the bookstore is an online entity, the e-book files 295 may alternately be transferred from the book repository to the customer 290.

Within the book creation and publishing system 200, an information bus 240 provides a mechanism for the transfer of information between the functional units of the book creation and publishing system 200. Further, the collaborator group 205, the printer 270, the bookstore 285 communicate through the network 210 to the book creation and publishing system 200. The network 210 having a communication path to the information bus 240 for providing the flow of the screen displays and the information for the creating and publishing of the book.

It is apparent that the persons within collaborator group 205 may in fact be a single person performing any or all of the functions of the collaborators 206a, 206b, . . . , 206g. For instance, the author 206b may be the publisher as in a self publishing model. Additionally, in an academic environment, the publisher 206a, may be a teacher or instructor and the authors 206b or writers 206d may be members of a class. Similarly, the other collaborator 206a, 206b, . . . , 206g functions may be shared by the members of the class, where one student writes a chapter or section of the book and another student edits the section. The first student edits a section written by another student. This interchange of function allows the students to learn the critical thinking skills for creating intellectual content for independent publication.

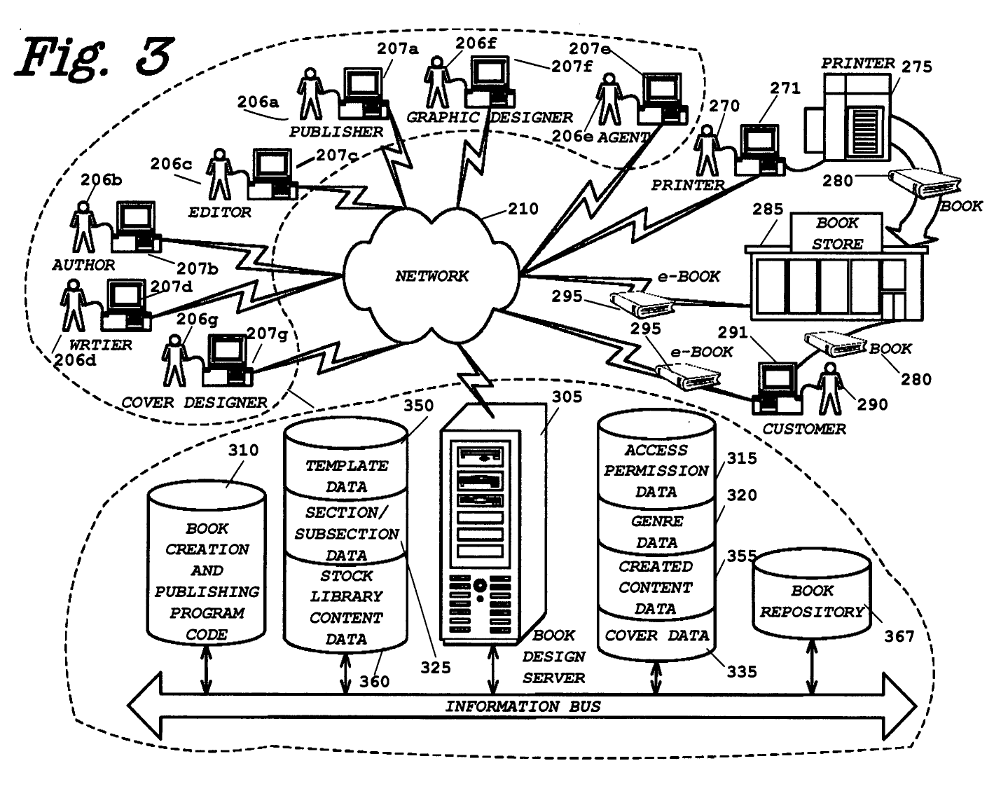

FIG. 3 is a functional block diagram of a networked computer system that executes a book creation and publishing method embodying the principles of this invention. Referring now to FIG. 3, the book creation and publishing system 300 is in communication with a digital communications network 210 such as the internet. A collaborator group 205 includes publishers 206a, authors 206b, editors 206c, writers 206d, agents 206e, publicists, graphic designers 206f, and cover designers 206g is essentially identical in form and function to those as described in FIG. 2. The collaborator group 205 as shown is exemplary and may include other persons (not shown) such as illustrators. Each collaborator 206a, 206b, . . . , 206g has access to a personal computer system 207a, 207b, . . . , 207g or any other computational device. Each of the personal computer systems 207a, 207b, . . . , 207g is in communication with the network 210, as described above.

The book creation and publishing system 300 includes a book creation and design server 305. The book creation and design server 305 executes book creation and publishing program processes that are encoded as digital data and stored on the program data storage device 310. The book creation and design server 305 in executing the book creation and publishing program processes emulates the functions of the book creation and publishing system 200 of FIG. 2.

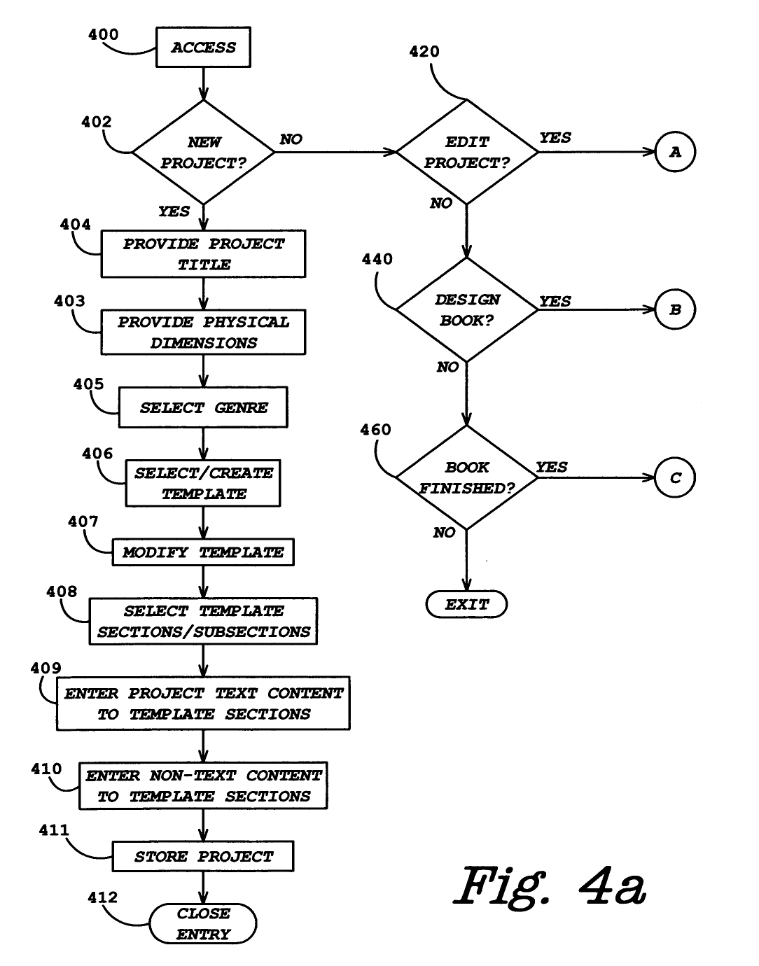

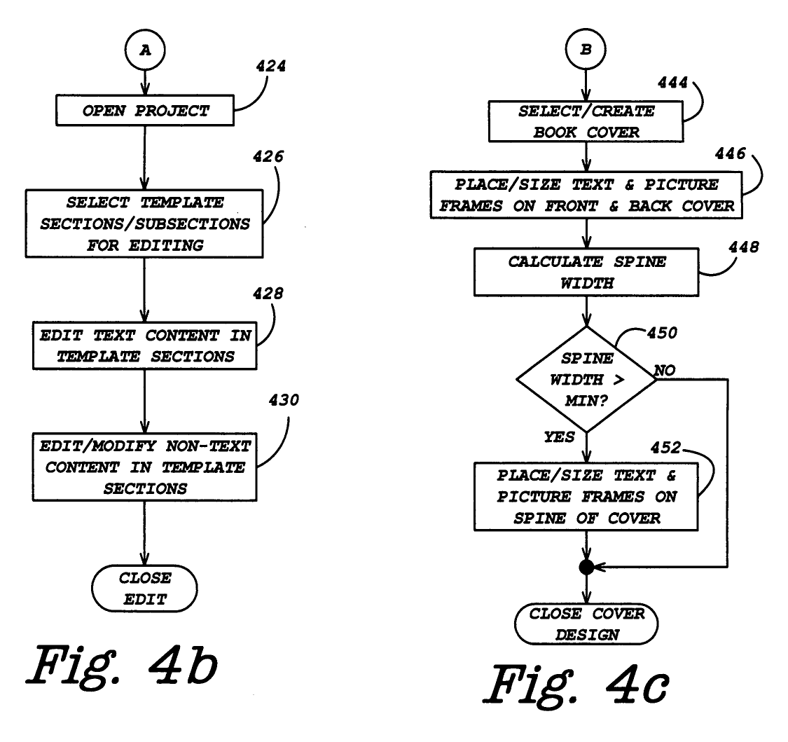

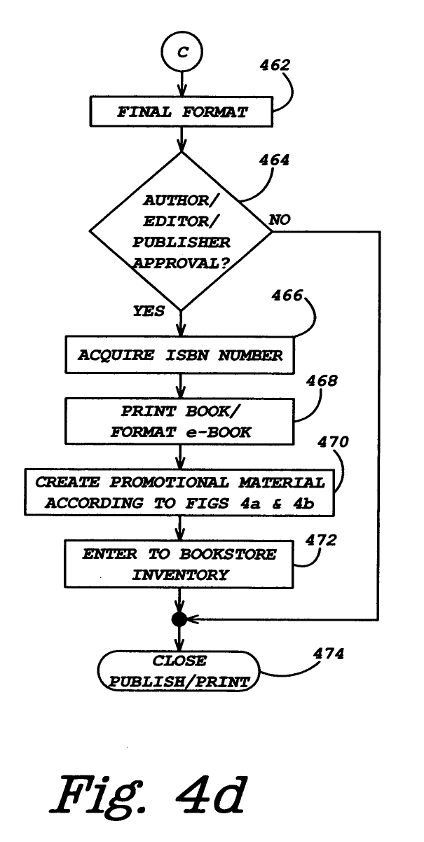

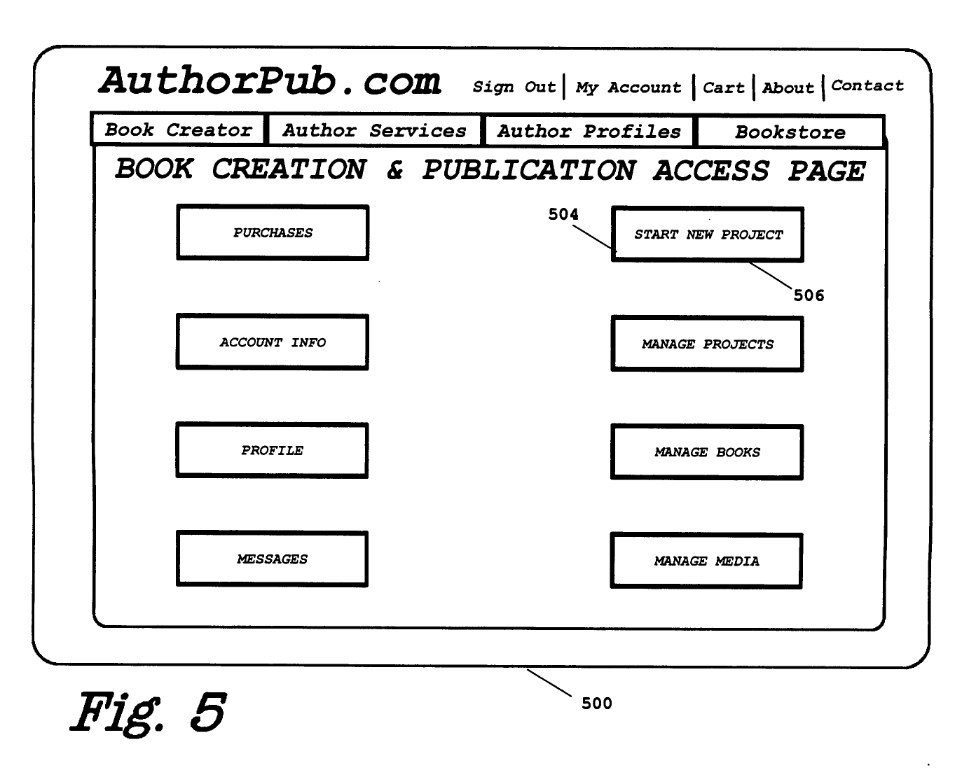

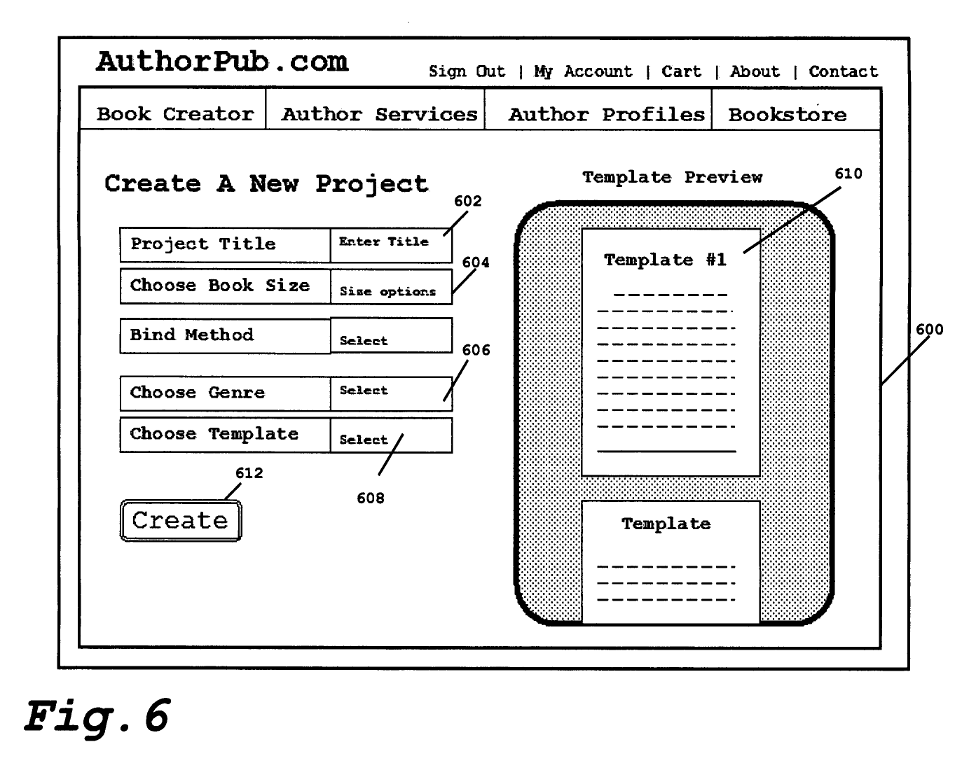

FIGS. 4a, 4b, 4c and 4d are flow diagrams illustrating a book creation and publishing method embodying the principles of this invention. The book creation and publishing method is encoded to define the program process and stored on the program data storage device 310. The book creation and design server 305 retrieves the encoded book creation and publishing program process and decodes the program data to execute the method as described in FIGS. 4a, 4b, 4c, and 4d. Referring simultaneously to FIGS. 3, 4a, 4b, 4c and 4d, one person 206a, 206b, . . . , 206g of the collaborator group 205, is presented with a screen display requesting a user identification and a password to gain access (Box 400) to the book creation and publishing system 300. The person gaining access is then presented with screen display showing a book creation and publishing access page 500 as shown in FIG. 5. The program process then queries (Box 402) if the person gaining access has pressed the linkage button 504 for starting a new project. If the person is starting a new project, the person gaining access is an author and/or publisher that are creating the content for publishing. The person is then presented with a screen display project creation page 600 as shown in FIG. 6. The person fills in the form for providing the title 602 of the project (Box 403), for providing the dimensions 604 of the project (Box 404), for selecting a genre 606 for the project (Box 405), and creating or selecting a template 608 within the genre (Box 406). The genres, for example, may be fiction, non-fiction, poetry, self-help, text book. Within the overall genres, there maybe other classifications such as fiction may include mysteries, adventure, spy thriller, romance, and number of other classifications. Each of the genres includes at least one template defining the basic structure. The template structures for the genres are stored in the template data base 350. A sample 610 of the selected template is displayed within the project creation page. Once the project creation form is completed, the creation button 612 is selected to initiate the creation of the personalization of the project manuscript that is then stored on the manuscript database 355.

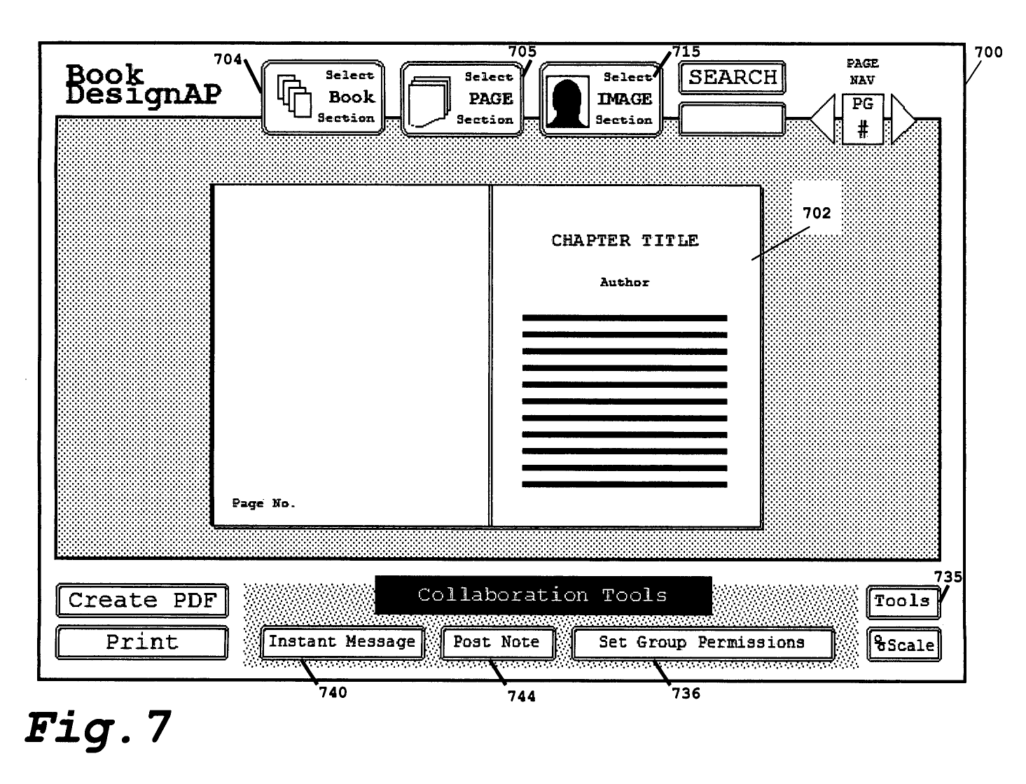

A screen display 700 as shown in FIG. 7 of a structural framework of the template is then provided to the GUI of the associated personal computer system 207a or 207b of the person creating the project. A representative page 702 of the structural framework is shown and the person creating the project can then modify (Box 407) the template. Templates are inclusive of margins, fonts, column widths, alignments, point sizes and other attributes all of which may be modified by the project owner to create a custom style.

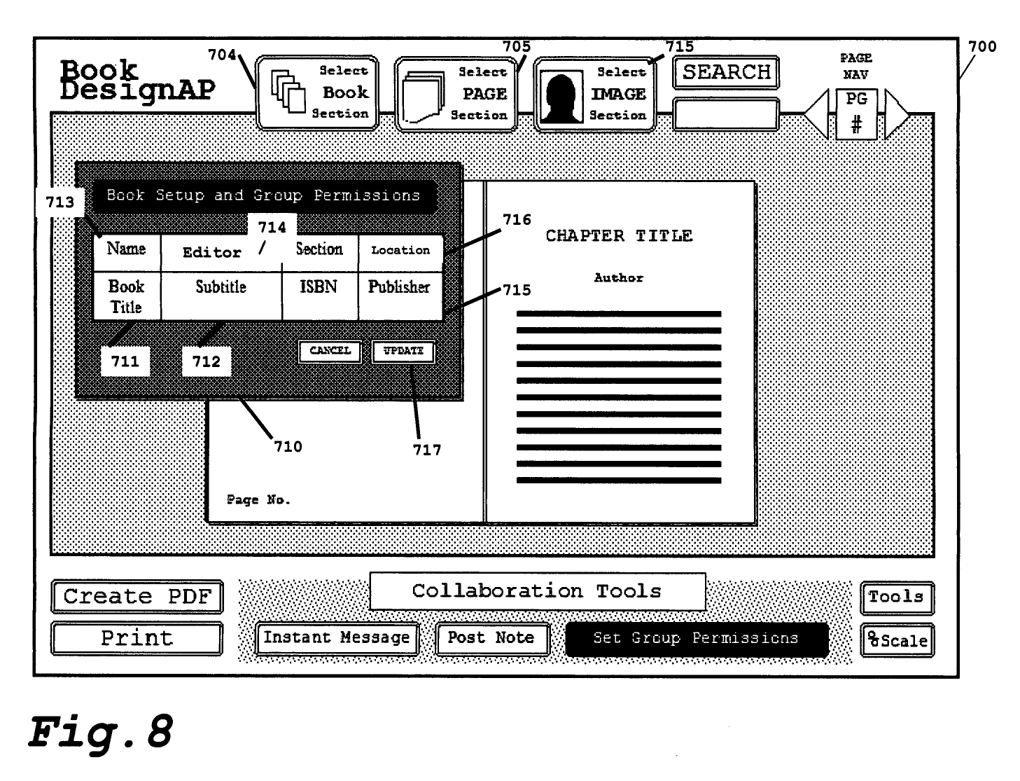

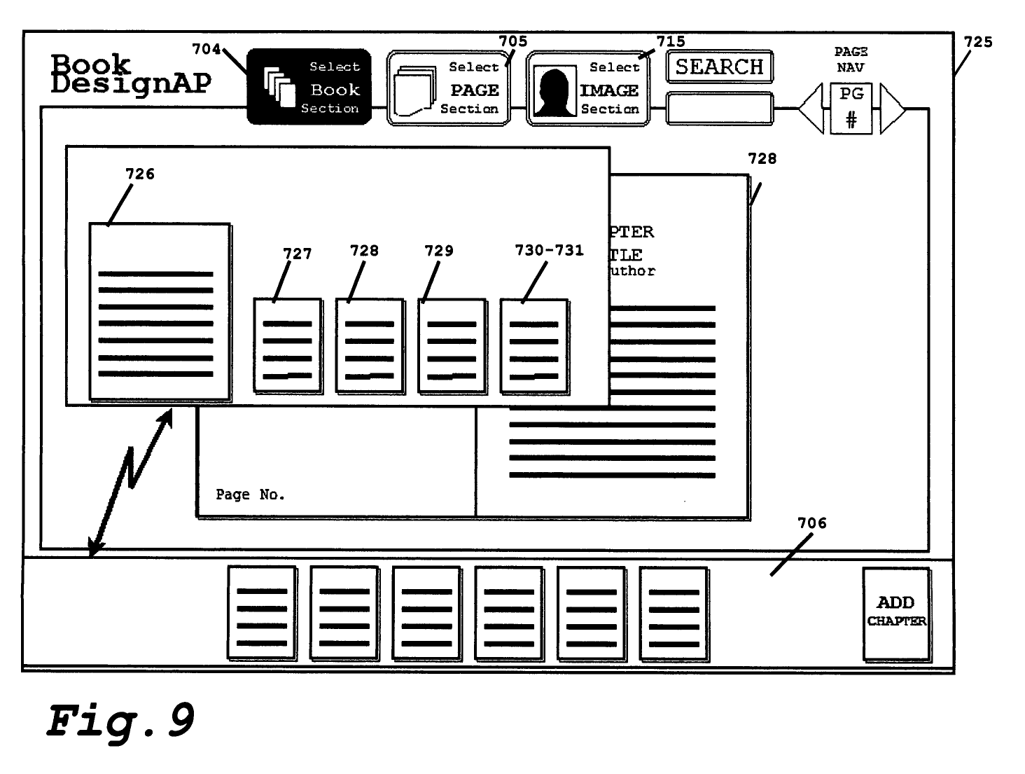

As part of the modification (Box 407) of the template, the person can press the book setup button 704. This brings up a separate screen display showing a basic setup form 710 for the project, as shown in FIG. 8. The setup form provides for the project (book) title 711, a project subtitle 712, an author's name 713, an editor's name 714, a publisher's name 715, and a publisher's location 716. It is apparent that other information may be used for the setup of the project and still be in keeping with the intent of this embodiment. Upon completion of the form, the update button 717 is pressed to save the information as part of the manuscript in the manuscript database 355. The template sections/subsections are then chosen (Box 408). In FIG. 7, section/subsection button 705 is pressed in the screen display presented at the GUI of the associated personal computer system 207a or 207b of the person creating the project. This initiates the appropriate program process for presenting the screen display 725 of the project as shown in FIG. 9. The representative page 702 is shown with thumbnails for each of the sections and subsections 706. The types of sections and subsections that may be selections include, for example, a title page 726, copyright page 727, at least one page illustrating a chapter format 728, a dedication page, table of contents page, an epilogue 729, an afterward 730, an author's brief biography 731 and many other section and subsection page types. The sections and subsections formats are then included within the book's structural framework and then the section/subsection selector process stores the books structural framework with the sections and the subsection to the manuscript database 355.

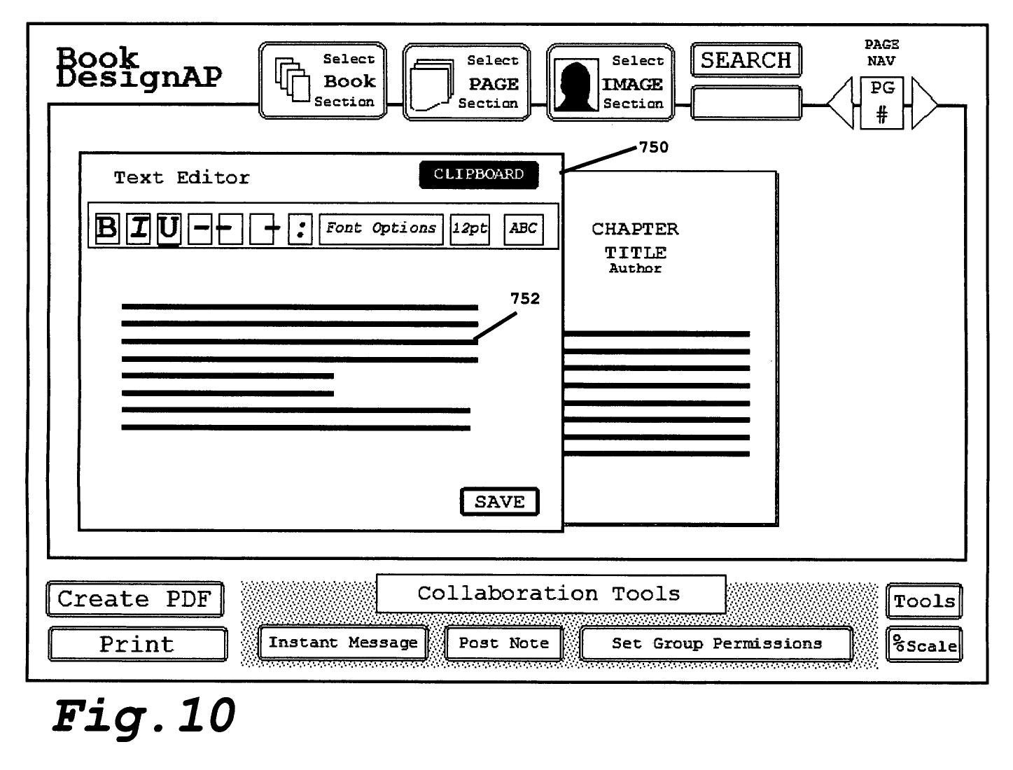

The project text is entered (Box 409) is entered to the template sections. To enter (Box 409) the text, the manuscript editor program process is activated. The manuscript editor program process generates a screen display for an editor function 750 is presented at the GUI of the associated personal computer system 207a or 207b of the person creating the project. The manuscript editor 750 of FIG. 10 permits the entry of the text 752 in either as a manual entry or as cut-and-paste from another external word processor. Content can also be imported into the text editor using a browser upload found on all standard PC operating systems. This tool allows .TXT, XML and PDF file uploads.

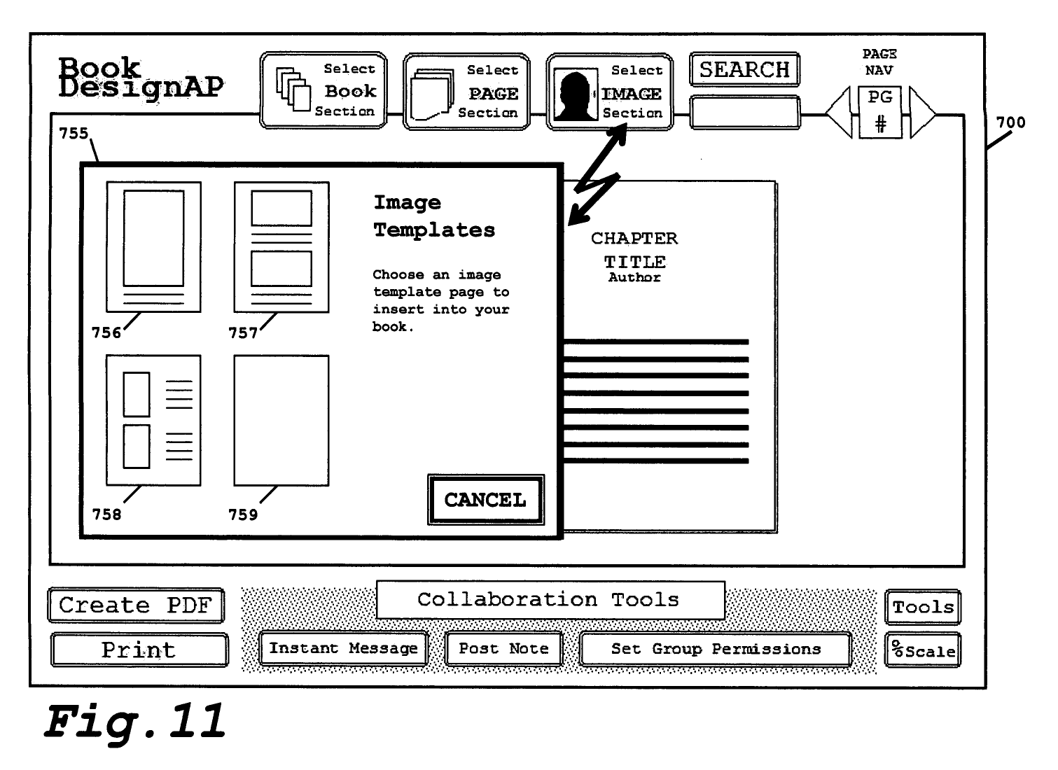

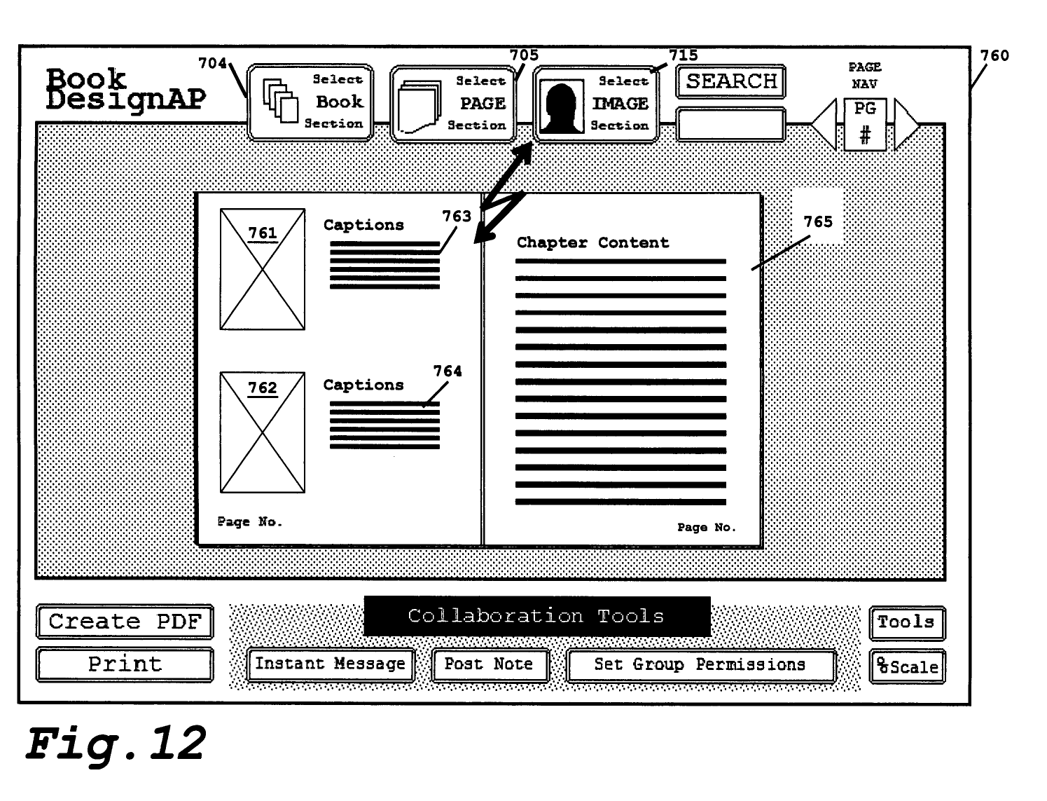

Images are inserted (Box 410) to the template sections. In FIG. 7, the graphic content library button 715 is pressed and a screen display of the graphic page template page 755 as shown on FIG. 11 is presented on the GUI of the associated personal computer system 207a or 207b of the person creating the project. The graphic page template page 755 provides a variety of page formats 756, 757, 758, and 759 for the location of graphic images in relation to the text of the page. One or more of the page formats 756, 757, 758, and 759 is chosen and placed on the pages 760 of the project as displayed on the GUI of the associated personal computer system 207a or 207b of the person creating the project as shown in FIG. 12. Once one of the page formats 756, 757, 758, and 759 is chosen the graphic is imported from the graphic content library database 360 to be inserted (Box 410) in the project. The images 761 and 762 are placed such that text captions may be place adjacent to the graphic images.

Once the initial entry of the manuscript of the project with the appropriate graphic images are entered, the project is stored (Box 411) in the manuscript data base and the project is closed (Box 412).

Any of the collaborator 206a, 206b, . . . , 206g may then gain access (Box 400) to the book creation and publishing system 300. When person gaining access is presented with the screen display of the book creation and publishing access page 500, the program process then queries (Box 402) if the person gaining access has not selected the linkage button 504 for starting a new project. If the person has pressed the linkage button 506 for managing a project, the person is presented with a screen display for a project management page 800. The program process then queries (Box 420) whether one of the projects 805 is to be edited. If the person is to edit one of the projects 805, the project is selected by the person clicking on the selected project 805. The program process activates the screen display 725 of the project as shown in FIG. 9 to open (Box 422) the project. The person performing the editing of the project selects (Box 424) one of the sections or subsections 726, 727, 728, 729, 730, and 731 of the project for editing. The person now selects the portion of the project text for editing and the screen display for the text editor 750 of FIG. 10 is activated by the program process for presentation on the GUI. The person edits (Box 426) the text. At completion of the text editing, the screen display for the text editor 750 is closed and the screen display 725 of the project as shown in FIG. 9 is re-opened. A section or sub-section 726, 727, 728, 729, 730, and 731 of the project having graphic images is selected for editing or modification. The non-text content is then edited or modified (Box 428) by deleting the image and re-entering the image by selecting the graphic image select button 715 of the screen display 725 of the manuscript as shown in FIG. 9. The image is edited or modified in a separate graphic or photo editor and replaced in the content library database 360 of FIG. 3. The editing process is closed (Box 430) and the person performing the editing disconnects from the book creation and design server 305.

In the editing and modification of the text (Box 426) and non-text content (Box 428), multiple persons of the collaborator group 205 may be participating in the editing process. To facilitate the collaboration, the program process as executed on the book creation and publishing system 300 provides a chat tool or an instant messaging tool. Referring to FIG. 7, the screen display 700 of the project has an icon 740 for activating the instant messaging tool. The instant messaging tool 742 as shown in FIG. 14. This allows the person of the collaborator group 205 that is creating or editing content within the project to transmit a message to any of the other persons of the collaborator group 205 to discuss suggestions, issues, and questions with regards to the content. The instant messaging tool 742 permits the communication between the persons 206a, 206b, . . . , 206g of the collaboration group through their associated personal computer systems 207a, 207b, . . . , 207g or other network enabled communication devices (personal digital assistants, networked enabled cellular telephones, etc.).

Another tool for facilitation of the collaboration in the creation and editing of the content of the project 700 is a “sticky note” tool activated by an icon 744 of FIG. 7. Additionally in FIG. 14, a similar “sticky note” icon 744 is shown in the instant messaging window 742. Upon activation, of the “sticky note” icon 744, a “sticky note” tool 745 is associated with a block of the content (text or image) within the project. The “sticky note” tool 745 is visible such that when any of the collaborators 206a, 206b, . . . , 206g of the collaborator group 205 access the project 700, the “sticky note” 745 is visible for the person 206a, 206b, . . . , 206g of the collaborator group 205 to review and take action as necessary.

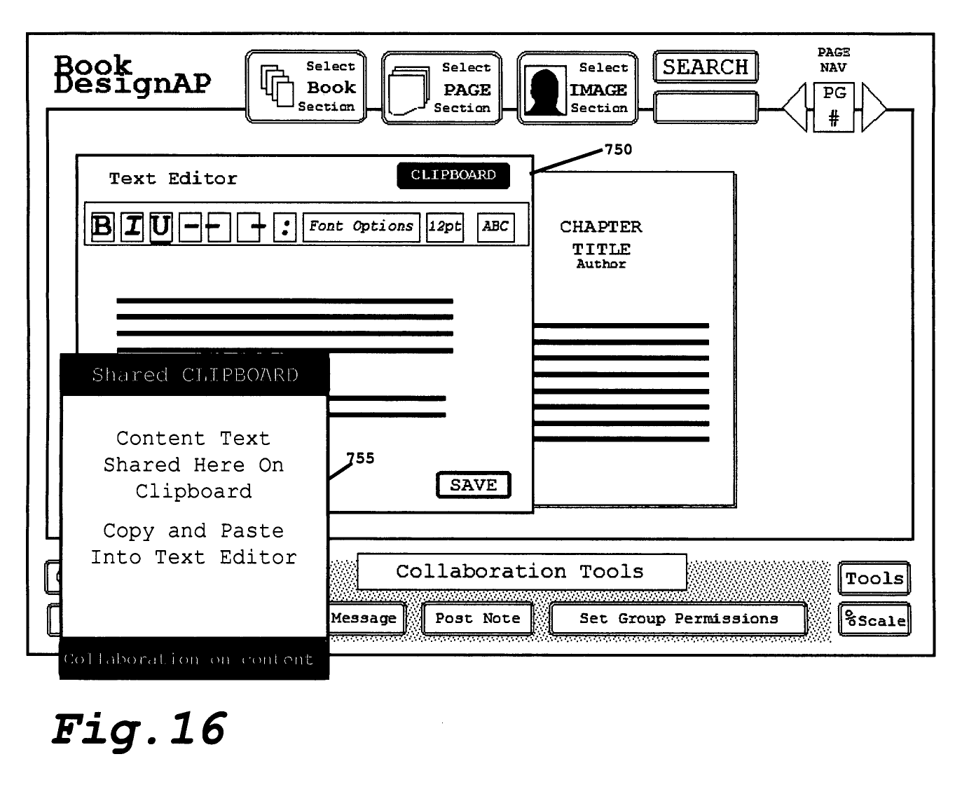

Another tool for facilitation of the collaboration is a clipboard tool 754 of FIG. 16. The clipboard tool 754 permits any of the collaborators 206a, 206b, . . . , 206g of the collaborator group 205 to copy and paste text that other collaborators 206a, 206b, . . . , 206g can access and paste as required within the content or the text editor 750. The clipboard tool 754 is accessible from the instant messaging tool 742 of FIG. 14 or the text editor 750 of FIG. 16. Each of the collaboration tools, the instant messaging tool 742, the “sticky note” tool 745, and the clipboard tool 754 provide an ease of flow of information in the creation and editing of the content of the project.

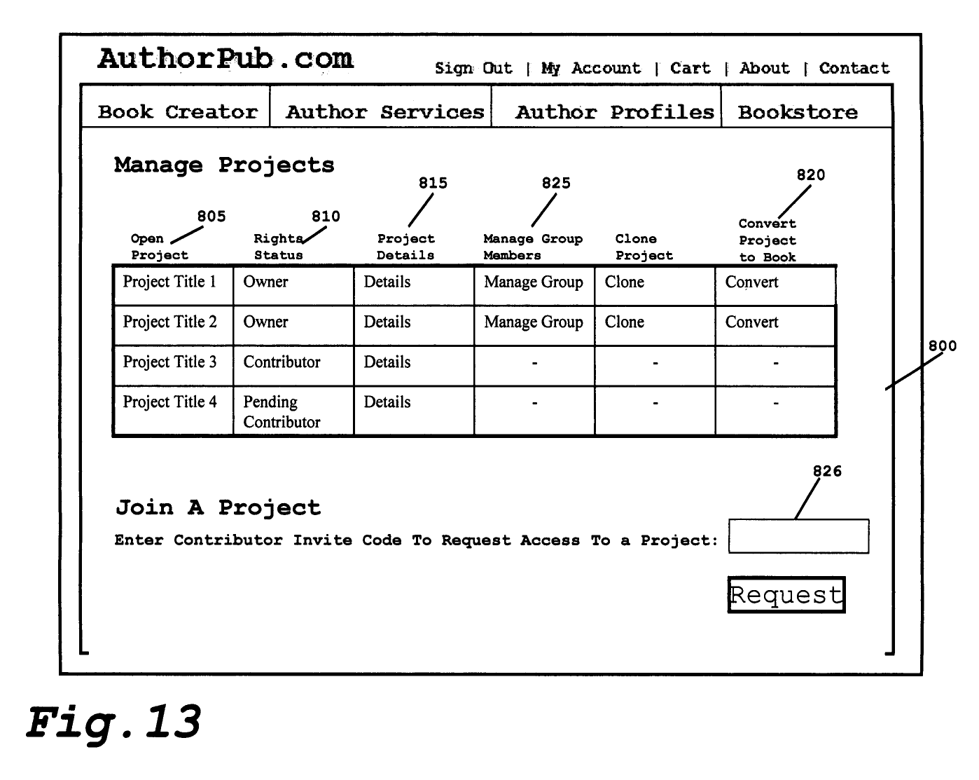

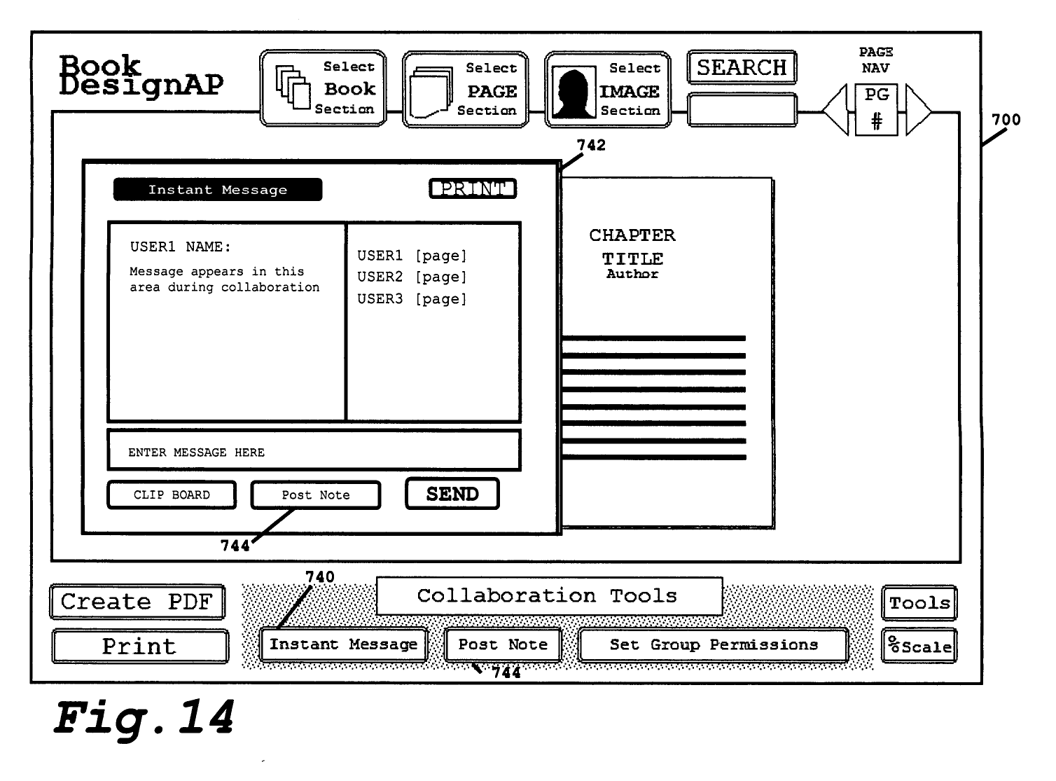

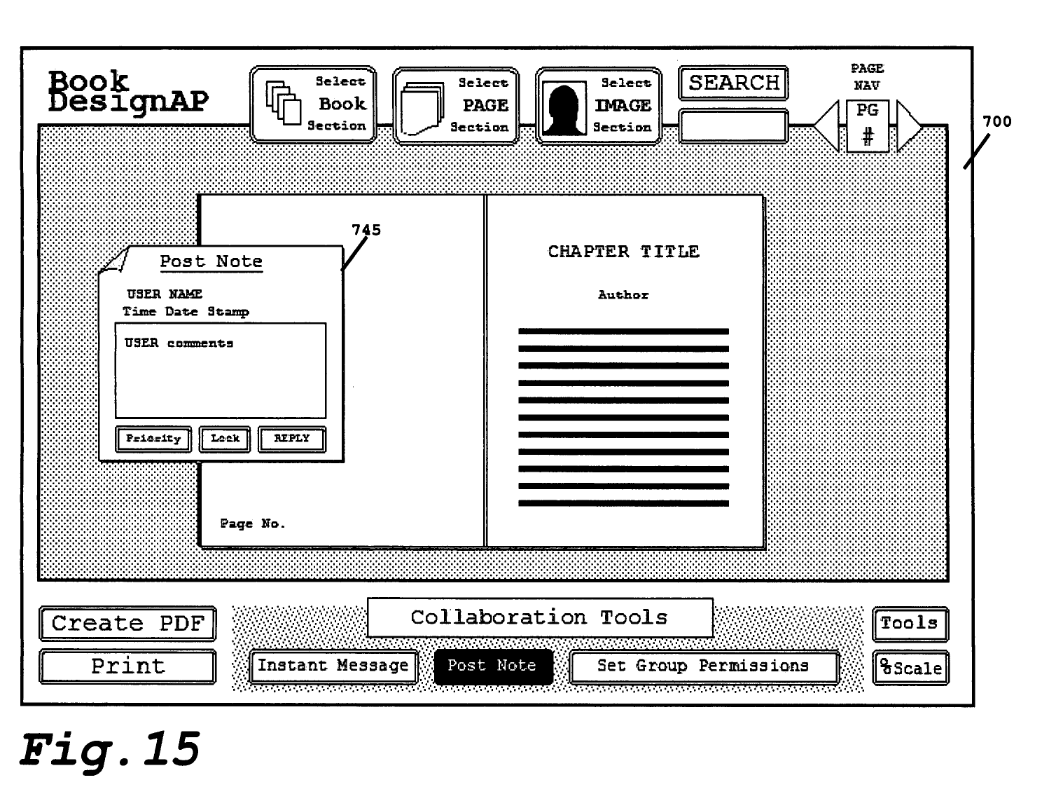

When the content creation (writing, etc.) and the editing for the project are nearly completed, one of the participants in the project will be designated as the cover designer 206g. The cover designer 206g will gain access (Box 400) to the book creation and publishing system 300 and will be presented with the screen display of the book creation and publishing access page 500, the program process then queries (Box 402) if the cover designer 206g has not pressed the linkage button 504 for starting a new project. If the cover designer 206g has pressed the linkage button 506 for managing a project, the cover designer 206g is presented with a screen display for a project access management 800 of FIG. 13. The program process then queries (Box 420) whether one of the projects 805 is to be edited. The project is selected and the program process activates the screen display 700 of the project as shown in FIG. 7 to open the project. The program process queries (Box 440) whether the tool icon 735 is selected and the cover designer tool 736 is chosen. If the cover designer tool 736 is chosen, the options for selecting (Box 442) a standard cover template from the template database 350 or designing (Box 442) a new cover. Alternately, the cover template may be modified to suit the application.

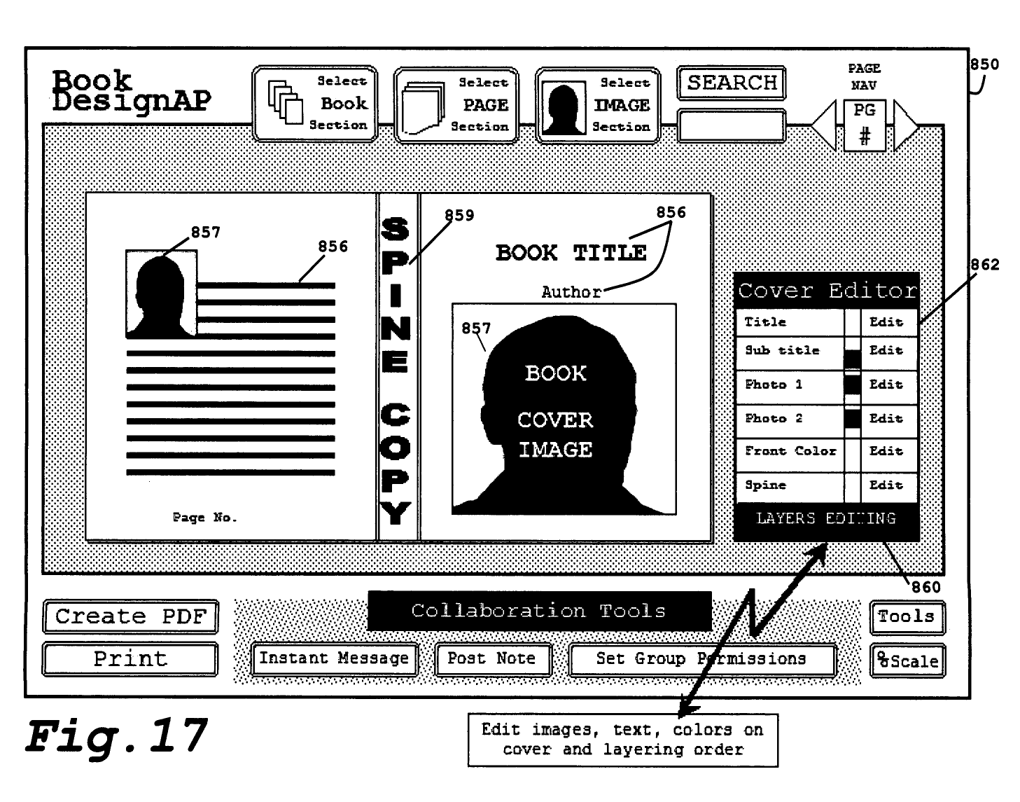

A screen display 850 as shown in FIG. 17 of a structural framework of a cover template 855 is then provided to the GUI of the associated personal computer system 207g of the cover designer 206g. The template 855 as shown illustrates the complete book cover, but may display either the front cover, the back cover, or the spine only. The text 856 and any images 857 for the cover are placed, sized and edited (Box 444). The layer editing controls 860 provide the controls for entry and editing of the text 856 and the entry of the image content 857.

The spine width is calculated using an algorithm based on number of pages contained in the book created in the book designer and paper thickness, known as PPI (pages per inch). The minimum number of pages for a book is 24 pages or 12 leafs.

The program process for cover design tool calculates (Box 446) the width of the spine of the book based on the number of pages in the manuscript of the book. The cover design tool then compares (Box 448) with a minimum spine dimension. If the calculated spine dimension is greater than the minimum, any text or images 859 are placed and edited (Box 450) on the spine. If the calculated spine dimensions are less than the minimum spine dimension, the cover design tool is closed (Box 452). Similarly, after the completion of the placing and editing (Box 450) off the spine, the cover design tool is closed (Box 452).

When the content creation (writing, etc.) and the editing for the project is nearly completed, the publisher 206a or one of the collaborators designated to be responsible for the publishers activities (i.e. the author 206b) will gain access (Box 400) to the book creation and publishing system 300 and will be presented with the screen display of the book creation and publishing access page 500, the program process then queries (Box 402) if the publisher 206a has not pressed the linkage button 504 for starting a new project and has pressed the linkage button 506 for managing a project, the publisher 206a is presented with a screen display for a project management page 800 of FIG. 13. The program process then queries (Box 420) whether one of the projects 805 is to be edited. If the project is not selected and the icon 820 for converting the project to a book is pressed. The project is formatted (Box 462) into the final format including the cover art and the text and image content and the print files are created for the physical printing of the book. Alternately, file format suitable for an e-book 295 is generated. The print files and the e-book files are then stored in the book repository 267 pending the printing and distribution or transmission of the book over the network 210 as an e-book. The program process as executed by the book creation and publishing system 300 queries (Box 464) whether the publisher 206a, the author 206b, or the editor 206c approve the book as formatted. It should be noted that any other person of the collaborator group 205 may be given approval rights in the process. If approval is not granted, the publishing and printing process is ended 474 and necessary content creation and editing is resumed.

If approval is granted, an ISBN number is acquired (Box 466). The printer 270 receives the print files from the book repository 267 through his computer workstation 271 in communication with the network 210. A printing device 275 that is capable of manufacturing the book is connected to the computer workstation 271 for printing (Box 468) the book 280. The printer may be an enterprise coupled to the book creation and publishing system 300 or in fact may be an element of the book creation and publishing system 300.

At this point, the promotional material is created (Box 470) by persons within the collaborator group 205 such as the author 206d, a writer 206d, a graphic designer 206f, or a publicist (not shown). The promotional material is created in a process equivalent to that described above for the creation of the book using the program processes described in FIGS. 4a and 4b.

Upon completion of the promotional material (Box 470) and the printing (Box 468), the book is entered (Box 472) into the inventory of the bookstore 285. The book 280 may be transferred directly from the printing device 275 as shown to a bookstore 285. Alternately, if the bookstore 285 is an online entity not having a physical distribution facility, the book 280 may be delivered directly (not shown) to the customer 290.

The bookstore 285 provides a facility for the display and promotion of the book. The customer may purchase either a physical book 280 or an electronic book 295. The bookstore 285 may store the e-book files and transfer the e-book 295 through the network 210 to the customer 290 through the customer's personal computer system 291. If the bookstore is an online entity, the e-book files 295 may alternately be transferred from the book repository to the customer 290.

When the book is published and available for sale, the creation and publishing process is completed and the book creation and publishing system 300 is available for creation and publishing for new content.

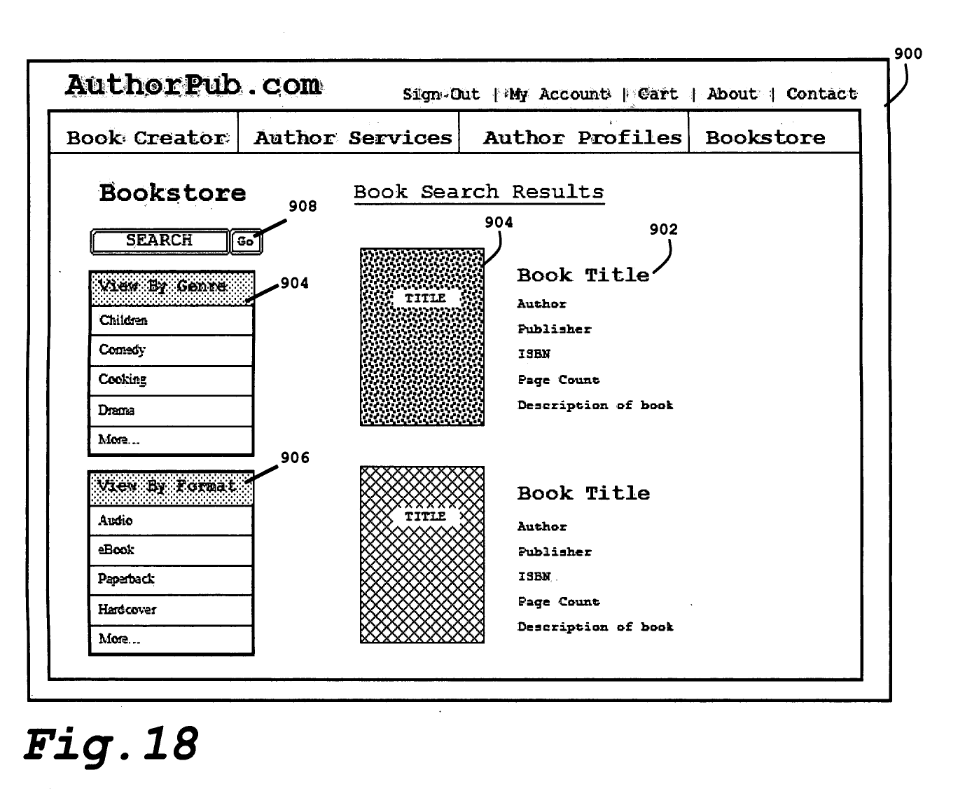

Alternately, if the book creation and publishing system 300 includes an on-line of the bookstore 285, the book creation and design server 305, will activate the program processes for operating the bookstore 285. The program process for operating the bookstore includes providing a screen display 900 of FIG. 18. The screen display 700 provides a catalog listing of the titles 902 with an image of the book cover 904. The catalog may be sorted by a genre by selecting the one of the icons 904. Further, the catalog may be view according to the format types 906 of the book offerings. Additionally, a specific title may be searched 908. For purchasing the book, the title 902 is selected and the promotional material for the book is displayed along with a button for selecting to purchase the book.

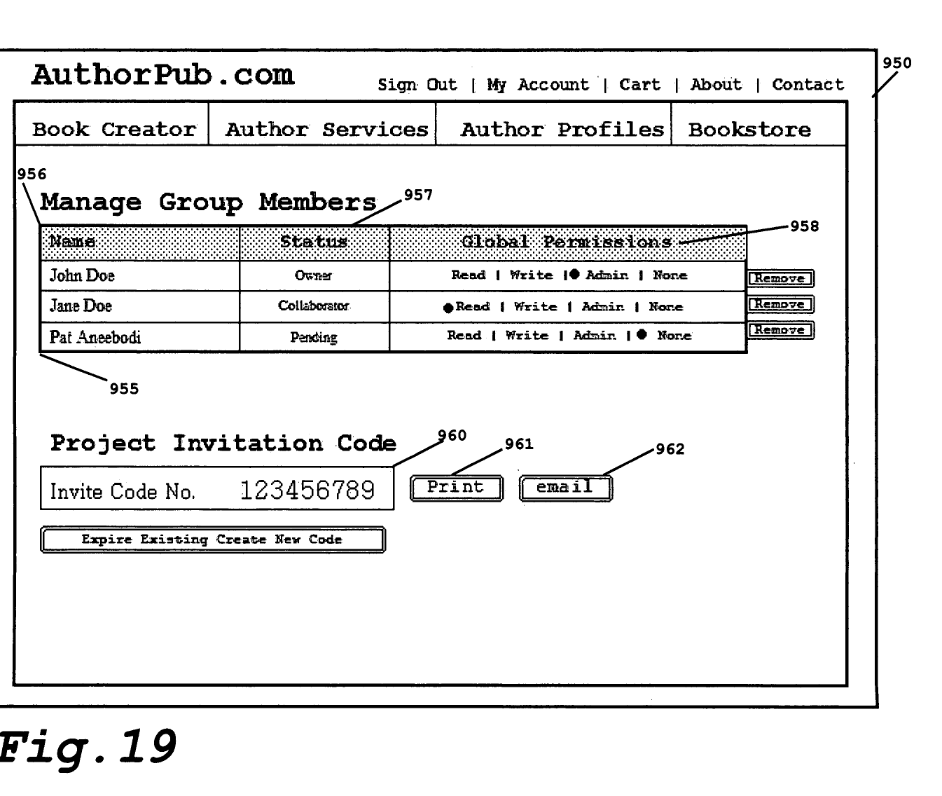

Returning to FIGS. 4a and 13 and referring to FIG. 19, the control of the a user identification and a password to gain access (Box 400) to the book creation and publishing system 300 is managed by a responsible person of the collaborator group 205 such as the publisher 206a. The user identifications and a passwords to gain access (Box 400) to the book creation and publishing system 300 are stored in an access permission database 315. The publisher 206a accesses the project management page 800 of FIG. 13 and selects the manage group choice of the desired project. The publisher 206a is presented with a screen display for group management page 950 of FIG. 19.

The publisher 206a reviews a list 955 of the collaborators. The collaborator group member list 955 itemizes the name of the collaborator 956, their status 957, and their access permissions 958. The collaborator status 957 may be their designation as a collaborator or with a description of the function they are to perform. The access permissions 958 designates the access to the project that the collaborator may have. The collaborator may have only a read person with not ability to modify the project or write permission with ability to change the project, an administrator permission with the ability to modify the project and control the collaborators. No permissions means that the person has been invited to perform some function but has not gained access to the project.

The publisher 206a may invite someone to become a member of the collaboration group by transmitting an invitation code 960 to the invite. The publisher 206a may print the invitation by selecting the print option 961 or send electronic mail (email) to the invitee. Upon gaining access (Box 400), the invited person enters the contributor invitation code 826 of FIG. 13 and requests entry. The publisher 206a allows entry and the person becomes a member of the collaborator group 205.

In another embodiment, a business method for creating and preparing a book for sale includes the steps as described above in FIGS. 4a, 4b, 4c and 4d and is completed by selling the book or e-book to a customer.

In another embodiment, the book creation and publishing process is executed in an apparatus that executes the steps described above in FIGS. 4a, 4b, 4c and 4d. In the apparatus, a group of computers similar to the personal computer systems 207a, 207b, . . . , 207g of FIGS. 2 and 3 will execute the steps of the process as described in FIGS. 4a, 4b, 4c and 4d.

The embodiments as described provide apparatus and methods for providing publishers and authors the organizational and creative tools to professionally create books inclusive of writing, graphics and multi-media. The apparatus and methods further enable users to design and format their publication with minimal effort. In the embodiments that include book creation and design server 305, the book creation and design are uniquely completed in a “real-time” environment without relying on “web-server” resources. Instead, an Adobe Flash interface coupled with text editing software is used to manipulate the input in a “What-You-See-Is-What-You-Get” (W.Y.S.I.W.Y.G.) environment. The user is able to professionally design a publication. Once this step is completed the user can “save” and preview images of the “print-ready” publication that is created by on the book creation and design server 305. The apparatus and methods of the embodiments further provide publishing resource tools that allow publishers to create and share writing assignments, assign authors to collaborative content creating tasks, monitor group authoring writing and approve or disapprove all input provided by the authors. The Publisher can also comment and make suggestions specific to the author content for the purpose of editing and revision. In a step-by-step process, publisher and authors can select from provided design styles and images or upload their own images to create professional looking publications. Once the publisher approves all content and designs and images the publication can be converted to a “print-ready file” and or an e-book and stored in a database on the book creation and design server 305. A bookstore associated with the apparatus and methods allow books to be viewed and purchased.

The embodiments as described provide apparatus and methods for providing publishers and authors the organizational and creative tools to professionally create books inclusive of writing, graphics and multi-media. The apparatus and methods further enable users to design and format their publication with minimal effort. In the embodiments that include a book creation and design server 305, the book creation and design are uniquely completed in a “real-time” environment without relying on “web-server” resources. Instead, an Adobe Flash interface with a text editor is used to manipulate the input in a “What-You-See-Is-What-You-Get” (W.Y.S.I.W.Y.G.) environment. The user is able to professionally design a publication. Once this step is completed, the user can “save” and preview images of the “print-ready” publication that is created by on the book creation and design server 305. The apparatus and methods of the embodiments further provide publishing resource tools that allow publishers to create and share writing assignments, assign authors to collaborative content creating tasks, monitor group authoring writing and approve or disapprove all input provided by the authors. The publisher can also comment and make suggestions specific to the author content for the purpose of editing and revision. In a step-by-step process, publisher and authors can select from provided design styles and images or upload their own images to create professional looking publications. Once the publisher approves all content and designs and images the publication can be converted to a “print-ready file” and or an e-book and stored in a database on the book creation and design server 305. A bookstore associated with the apparatus and methods allow books to be viewed and purchased.

While this invention has been particularly shown and described with reference to the preferred embodiments thereof, it will be understood by those skilled in the art that various changes in form and details may be made without departing from the spirit and scope of the invention.

The invention claimed is:

1. A content creation and publishing system that allows a user that is an independent publisher with optional collaborators to create and publish a content comprises:
a genre selector that assists the user in selecting one of a plurality of genre to which the content will be assigned, each genre including at least one template providing structure for the content to be designed;
a section partitioner in communication with the template to allow the user to select at least one section to be incorporated into the content;
an editing apparatus is in communication with at least one of the sections of the content to allow the user to generate and edit matter that is inserted into the section; and
a cover designer that receives a number of pages in the content and calculates a content size and allows the user to generate and edit the matter to be displayed on the cover.

2. The content creation and publishing system of claim 1 wherein the content is a book, magazine, audio, or video publication.

3. The content creation and publishing system of claim 1 wherein matter is text or illustration.

4. The content creation and publishing system of claim 1 wherein the section partitioner comprises a subsection partitioner in communication with the template to allow the user to organize and edit specific sub-sections within each content section.

5. The content creation and publishing system of claim 1 wherein the sections and subsections are chapters, sub-chapters, paragraphs, illustrations or other distinct portions of the content.

6. The content creation and publishing system of claim 1 further comprising a user permission apparatus to allow permission to be granted to the collaborators of the content.

7. The content creation and publishing system of claim 1 further comprises a plurality of collaboration tools that allow multiple users, upon accessing the content matters, to communicate in the generation and editing of the matter.

8. The content creation and publishing system of claim 7 wherein the collaboration tools comprise:
a commenting device that provides a notational device that is anchored to selected portions of the matter for communication of recommendations and comments regarding the selected portions of matter.;
a messaging device that allows one collaborator to communicate with regards to a selected portion of the matter by sending short text messages within a network environment to one another collaborator

9. The content creation and publishing system of claim 1 further comprising a distribution system which for preparation of the content for printing or disseminating as physical content or as electronic content.

10. The content creation and publishing system of claim 1 further comprising a store to allow for promotion and sales of the physical content or electronic content.

11. The content creation and publishing system of claim 9 wherein the physical content or the electronic content include audio and visual media to augment the text and graphics of the physical content or the electronic content.

12. A content creation and publishing method to allow a user that is an independent publisher with optional collaborators to create and disseminate their matter as professionally appearing contents, deliverable in both electronic and printed formats comprises:
partitioning the content into sections to allow the user to organize and edit each content section;
editing at least one of the sections of the content to generate and edit matter inserted into the section; and
designing a cover for the content by calculating a content size from a number of pages within the content and generating and editing matter to be displayed on the cover.

13. The content creation and publishing method of claim 12 wherein the content is a book, magazine, audio, or video publication.

14. The content creation and publishing method of claim 12 wherein matter is text or illustration.

15. The content creation and publishing method of claim 12 wherein the partitioning the content into sections comprises partitioning sections into subsections to allow the user to organize and edit specific sub-sections within each content section.

16. The content creation and publishing method of claim 12 further comprises granting by a user permission to allow the collaborators access to the content for generating and editing matter for the content.

17. The content creation and publishing method of claim 12 further comprises collaborating of multiple users with permissions to access the content to communicate in the generation and editing of the matter.

18. The content creation and publishing method of claim 12 wherein collaborating of multiple users comprises, using collaboration tools for communicating between collaborators.

19. The content creation and publishing method of claim 18 wherein the commenting device comprises:
a notational device that is anchored to selected portions of the matter for communication of recommendations and comments regarding the selected portions of matter; and
a messaging device that allows the to communicate with regards to a selected portions of the matter by sending short text messages within a network environment to one another.

20. The content creation and publishing method of claim 12 further comprises formatting the physical content for printing and disseminating as a physical content or as an electronic content.

21. The content creation and publishing method of claim 12 further comprises receiving the content or electronic content and selling the content or electronic content to a customer.

22. A computer-accessible data storage medium having instruction data code, which, when executed on a computer, performs a program process that performs a content creation and publishing method to allow a user that is an independent publisher with optional collaborators to create and disseminate their matter as professionally appearing content, deliverable in both electronic and printed formats, wherein the content creation and publishing method comprises:
partitioning the content into sections to allow the user to organize and edit each content section;
editing at least one of the sections of the content to generate and edit matter inserted into the section; and
designing a cover for the content by calculating a content size from a number of pages within the content and generating and editing matter to be displayed on the cover.

23. The computer-accessible data storage medium of claim 22 wherein the content is a book, magazine, audio, or video publication.

24. The computer-accessible data storage medium of claim 22 wherein matter is text or illustration.

25. The computer-accessible data storage medium of claim 22 wherein the partitioning the content into sections comprises partitioning sections into subsections to allow the user to organize and edit specific sub-sections within each content section.

26. The computer-accessible data storage medium of claim 22 wherein the content creation and publishing method further comprises granting by a user permission to allow the collaborators access to the content for generating and editing matter for the content.

27. The computer-accessible data storage medium of claim 22 wherein the content creation and publishing method further comprises collaborating of multiple users with permissions to access the content to communicate in the generation and editing of the matter.

28. The computer-accessible data storage medium of claim 22 wherein collaborating of multiple users comprises, using collaboration tools for communicating between collaborators.

29. The computer-accessible data storage medium of claim 28 wherein the commenting device comprises:
a notational device that is anchored to selected portions of the matter for communication of recommendations and comments regarding the selected portions of matter; and
a messaging device that allows the to communicate with regards to a selected portions of the matter by sending short text messages within a network environment to one another.

30. The computer-accessible data storage medium of claim 22 wherein the content creation and publishing method further comprises formatting the content for printing and disseminating as a physical content or as an electronic content.

31. The computer-accessible data storage medium of claim 22 wherein the content creation and publishing method further comprises receiving physical content or electronic content and selling the physical content or electronic content to a customer.

32. A method of business to allow a user that is an independent publisher with optional collaborators to create and disseminate their matter as professionally appearing content, deliverable in both electronic and printed formats for sale comprises:
partitioning the content into sections to allow the user to organize and edit each content section;
editing at least one of the sections of the content to generate and edit matter inserted into the section; and
designing a cover for the content by calculating a content size from a number of pages within the content and generating and editing matter to be displayed on the cover.

33. The method of business of claim 32 wherein the content is a book, magazine, audio, or video publication.

34. The method of business of claim 32 wherein matter is text or illustration.

35. The method of business of claim 32 wherein the partitioning the content into sections comprises partitioning sections into subsections to allow the user to organize and edit specific sub-sections within each content section.

36. The method of business of claim 30 further comprises granting by a user permission to allow the collaborators access to the content for generating and editing matter for the content.

37. The method of business of claim 32 further comprises collaborating of multiple users with permissions to access the content to communicate in the generation and editing of the matter.

38. The method of business of claim 32 wherein collaborating of multiple users comprises, using collaboration tools for communicating between collaborators.

39. The method of business of claim 38 wherein the commenting device comprises:
a notational device that is anchored to selected portions of the matter for communication of recommendations and comments regarding the selected portions of matter; and
a messaging device that allows the to communicate with regards to a selected portions of the matter by sending short text messages within a network environment to one another.

40. The method of business of claim 32 further comprises formatting the content for printing and disseminating as a physical content or as an electronic content.

41. The method of business of claim 32 further comprises receiving the physical content or electronic content and selling the content or electronic content to a customer.
